(19) United States
(12) Patent Application Publication
(10) Pub. No.: US 2019/0349689 A1
(43) Pub. Date: Nov. 14, 2019

(54) Efficiency of Miniature Loudspeakers

(71) Applicant: Bose Corporation, Framingham, MA (US)

(72) Inventors: Mark A. Hayner, Belmont, MA (US); Christopher J. Cheng, Arlington, MA (US); Csaba Guthy, Hopkinton, MA (US); Weidong Zhu, Newton, MA (US)

(73) Assignee: Bose Corporation, Framingham, MA (US)

(21) Appl. No.: 15/975,461

(22) Filed: May 9, 2018

(51) Int. Cl. H04R 9/06; H04R 31/00; H04R 7/06; B32B 38/18

(52) U.S. Cl. CPC H04R 9/06; H04R 31/003; H04R 7/16; B32B 38/18; H04R 7/06

(57) ABSTRACT

A solid piston having a closed shape is attached to a solid support surrounding the piston and corresponding in shape to the shape of the piston by a layer of compliant material adhered to a top surface of the piston and a top surface of the support. The layer of compliant material includes an open central area exposing the top surface of the piston through the open area. An assembly for an electroacoustic transducer includes a piston, which is an elliptical plate of silicon having a flat top surface and serving as the diaphragm, an elliptical support ring of silicon surrounding the piston and separated from the piston by a gap, and a layer of compliant material adhered to a top surface of the support ring and to the top surface of the piston, suspending the piston in the gap. An elliptical or cylindrical motor is coupled to the piston.

### BACKGROUND

This disclosure relates to improving the efficiency of miniature loudspeakers.

U.S. Pat. No. 9,913,042, incorporated here by reference, describes a miniature electroacoustic transducer, i.e., a loudspeaker. The loudspeaker described in the '043 patent, shown in FIG. 1, resembles a conventional electrodynamic loudspeaker, with a moving voice coil 10 attached to a bobbin 12 that moves a sound-radiating diaphragm 14 suspended from a housing 16, but the entire assembly has a diameter on the order of 4 mm. The diaphragm 14 is a flat plate, rather than the usual cone shape used in larger loudspeakers, and the plate and bobbin assembly may be referred to as a piston. The voice coil and bobbin in combination with a magnetic assembly 18 is referred to as the motor of the transducer.

U.S. patent application Ser. No. 15/222,539, also incorporated here by reference, describes a way to fabricate a piston top and suspension for the transducer of the '043 patent using micro-electrical mechanical systems (MEMS) processes. In particular, the '539 application describes coating a silicon wafer 20, shown in FIG. 2, with liquid silicone rubber (LSR) 22, and etching away most of the wafer to leave a thin disc 24 suspended from a surrounding ring 26 by a circular section 28 of the LSR. The disc 24 is attached to the bobbin (12 in FIG. 1), and serves as the piston top, while the surrounding 26 ring is attached to the transducer housing (16 in FIG. 1).

### SUMMARY

In general, in one aspect, a solid piston having a closed shape is attached to a solid support surrounding the piston and corresponding in shape to the shape of the piston by a layer of compliant material adhered to a top surface of the piston and a top surface of the support. The layer of compliant material includes an open central area exposing the top surface of the piston through the open area.

Implementations may include one or more of the following, in any combination. The exposed portion of the piston may include at least 50% of the surface area of the top surface of the piston. The piston may be a circular disc and the support may be a circular ring. The piston may be an elliptical plate, and the support may be an elliptical ring. The piston may be a shape that is longer in one dimension than another. The piston may also include support structures extending from a bottom surface of the piston, away from the compliant material layer. The support structures may not form a closed shape. The piston and support may include silicon. The compliant layer may include liquid silicone rubber (LSR).

In general, in one aspect, a layer of compliant material is adhered to a solid substrate. A portion of the substrate is removed to leave a piston, which has a closed shape, and a support surrounding the piston, detached from the piston, and corresponding in shape to the shape of the piston, the piston and support being attached to each other by the complaint material layer. A portion of the compliant material layer covering a central area of the piston is removed, exposing a portion of the top surface of the piston through the opening created by removing the compliant material.

Implementations may include one or more of the following, in any combination. The exposed portion of the piston may include at least 50% of the surface area of the top surface of the piston. Removing the portion of the silicon substrate causes the piston to be a circular disc and the support to be a circular ring. Removing the portion of the silicon substrate causes the piston to be an elliptical plate, and the support to be an elliptical ring. Removing the portion of the silicon substrate causes the piston to be a shape that is longer in one direction than in another. Removing the portion of the silicon substrate may cause the piston to also include a support structure extending from a bottom surface of the piston, away from the compliant material layer. The solid substrate may include silicon. The compliant layer may include liquid silicone rubber (LSR).

In general, in one aspect, an assembly for an electroacoustic transducer includes a piston, which is an elliptical plate of silicon having a flat top surface and serving as the diaphragm, an elliptical support ring of silicon surrounding the piston and separated from the piston by a gap, and a layer of compliant material adhered to a top surface of the support ring and to the top surface of the piston, suspending the piston in the gap.

Implementations may include one or more of the following, in any combination. An elliptical bobbin may be adhered to a perimeter of the piston, extending from the piston in a direction away from the layer of compliant material, with an elliptical voice coil would around the bobbin. The piston may also include a support structure extending from a bottom surface of the piston, away from the compliant material layer, at the perimeter of the piston. A circular bobbin may be adhered to a bottom surface of the piston opposite the top surface, extending from the piston in a direction away from the layer of compliant material, with a circular voice coil wound around the bobbin. The piston may also include a support structure extending from a bottom surface of the piston, away from the compliant material layer, on a circular path corresponding to the shape of the bobbin. The layer of compliant material may not extend over the entire top surface of the piston.

In general, in one aspect, an electroacoustic transducer includes a piston, which includes an elliptical plate of silicon having a flat top surface and serving as the diaphragm, an elliptical support ring of silicon surrounding the piston and separated from the piston by a gap, and coupled to a housing, a layer of compliant material adhered to a top surface of the support ring and to the top surface of the piston, suspending the piston in the gap, an elliptical bobbin adhered to a perimeter of the piston, and extending from the piston in a direction away from the layer of compliant material, an elliptical voice coil would around the bobbin, and an elliptical magnetic assembly positioned inside the bobbin and coupled to the housing. The layer of compliant material may not extend over the entire top surface of the piston.

In general, in one aspect, an electroacoustic transducer includes a piston, which includes an elliptical plate of silicon having a flat top surface and serving as the diaphragm, an elliptical support ring of silicon surrounding the piston and separated from the piston by a gap, and coupled to a housing, a layer of compliant material adhered to a top surface of the support ring and to the top surface of the piston, suspending the piston in the gap, a cylindrical bobbin adhered to a perimeter of the piston, and extending from the piston in a direction away from the layer of compliant material, a cylindrical voice coil would around the bobbin, and a cylindrical magnetic assembly positioned inside the bobbin and coupled to the housing. The layer of compliant material may not extend over the entire top surface of the piston.

Advantages include improving the efficiency of the loudspeaker while maintaining the ability to fit inside a human ear canal.

All examples and features mentioned above can be combined in any technically possible way. Other features and advantages will be apparent from the description and the claims.

### BRIEF DESCRIPTION OF THE DRAWINGS

FIG. 1 shows a cross-section of a miniature loudspeaker.

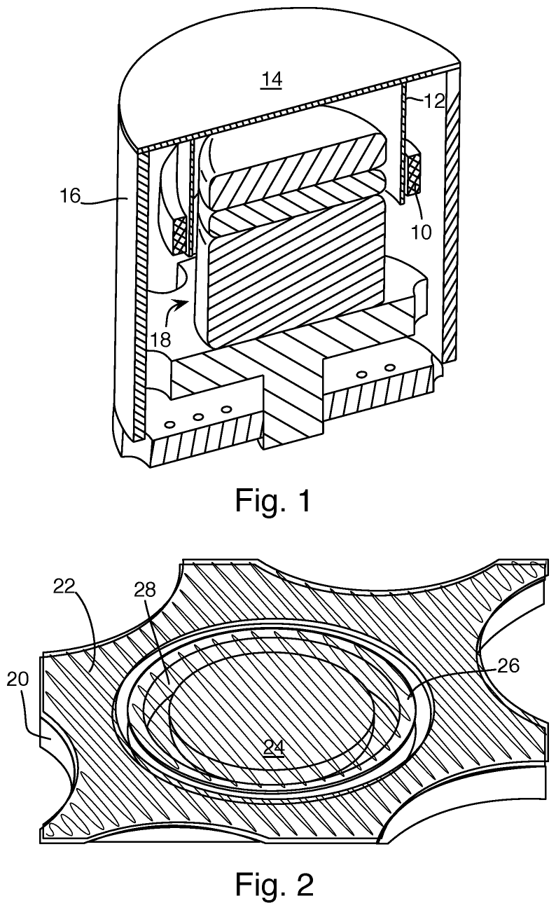

FIG. 2 shows a perspective view of the top of a silicon wafer etched to produce the piston top and suspension of the loudspeaker of FIG. 1.

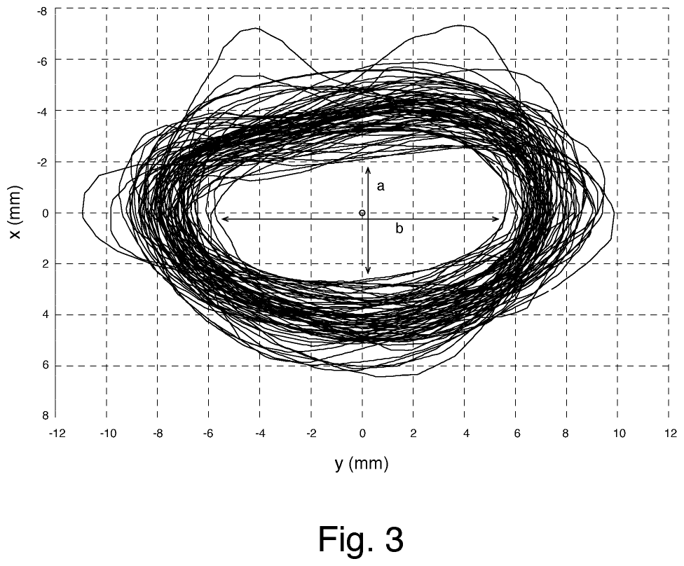

FIG. 3 shows a plot of ear canal measurements for a population.

FIGS. 4, 5, 6, and 7 show subassemblies of miniature loudspeakers.

### DESCRIPTION

This application describes several modifications to the loudspeaker described in the U.S. Pat. No. 9,913,043 and the Ser. No. 15/222,539 application to improve the efficiency of the loudspeaker, that is, the amount of sound energy that can be output for a given amount of electrical energy input. Generally speaking, the efficiency of a loudspeaker can be improved by increasing its sound-radiating surface area and overall motor volume, and decreasing the mass of the moving components (i.e., the piston, bobbin, and coil, and part or all of the suspension layer). When dealing with the miniature loudspeaker described above, the ways in which such modifications may be accomplished are not necessarily the same as what might be practical in a conventional loudspeaker.

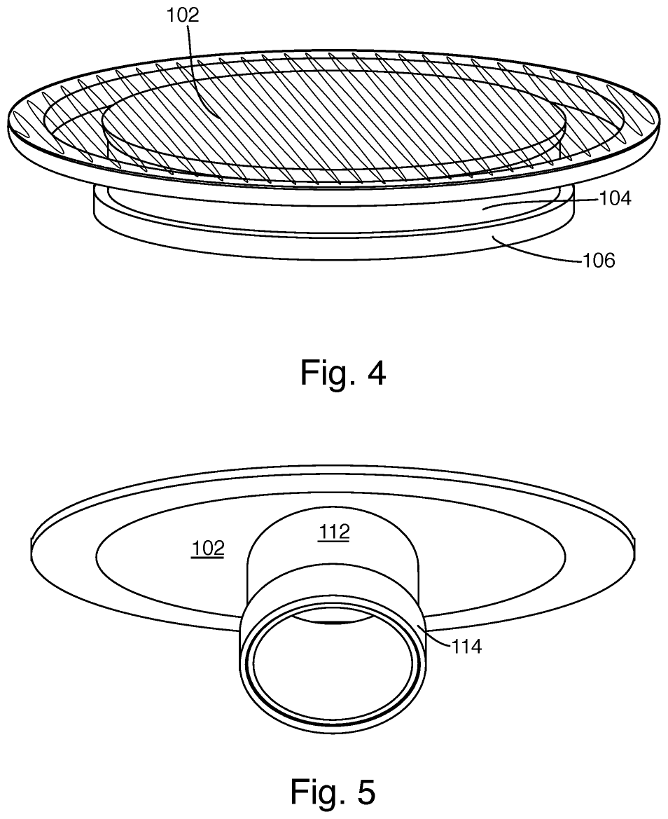

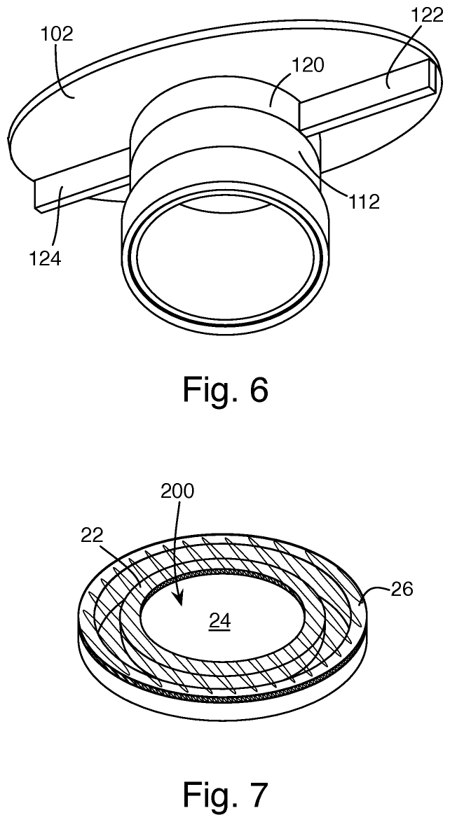

In some examples, the miniature loudspeaker is used as the driver of an in-ear headphone. In particular, the 4 mm diameter makes the loudspeaker small enough to fit inside a human ear canal, unlike the 10 mm or larger dynamic speakers usually used in earphone applications (other in-canal applications use balanced armature transducers, an entirely different electro-acoustic transducer design). A typical human ear canal is not circular in cross-section, but is generally a slightly asymmetrical oval, or kidney bean shape. FIG. 3 shows the cross-sectional shape near the entrance of ear canals, measured across a large population sample. The two dimensions marked ‘a’ and ‘b’ indicate that an elliptical shape measuring 4.5 mm by 11 mm is available in nearly all of the measured ears. An advantage of the MEMS fabrication processes used to shape the piston top, suspension, and support ring is that they can just as easily be made in any other shape as they can be circular, though some shapes will be more amenable to smooth piston motion than others. In the example of FIG. 4, the piston 102 is elliptical in shape. An elliptical shape that is 4 mm wide and 7 mm long will have 1.75 times the radiating area Sd of a 4 mm circular piston. This is more area than increasing the circular diameter to 5 mm, but will still fit in most adult human ear canals, and will generally behave in a stable manner when pushed and pulled by the loudspeaker motor. Such an increase in radiating surface area can improve the output of the loudspeaker by 6 dB for the same input power. In addition to making the piston elliptical, the bobbin 104 and voice coil 106 in FIG. 4 are also elliptical, allowing them to be attached around the perimeter of the piston. The magnetic structures, not shown, can also easily be made elliptical to match the bobbin and voice coil. Making the motor elliptical to fill the space behind the piston increases the motor volume, and therefore its efficiency 3, by the same factor of 1.75× as the surface area of the piston. Making the motor elliptical can also keep the force around the perimeter of the piston uniform, versus using a circular motor and attaching it to the bottom face of an elliptical diaphragm, as shown in FIG. 5, with circular bobbin 112 and voice coil 114, though it may be more difficult to manufacture. In both cases, the outer support ring for coupling to the driver housing is not shown. Other shapes may also be effective, such as a rectangle with chamfered corners, to name one example. Note that when we say “elliptical,” we do not necessarily mean a mathematically-true ellipse, but refer to ovals & oblong circular shapes generally.

The effective moving mass of the MEMS-fabricated piston and suspension can also be reduced. As mentioned in the '539 application, support structures can be omitted from the back side of the silicon plate that forms the piston top. The outer stiffening rib can be removed entirely, as shown in FIGS. 4 and 5, or segments may be retained where stiffening is needed, while removing it in other areas to reduce mass. An example design with a circular motor and an elliptical piston is shown in FIG. 6. In FIG. 6, the main stiffening rib 120 is around the circular area where the bobbin will attach, rather than around the perimeter of the piston. Additional stiffening ribs 122, 124 are provided along the major axis of the piston, from the circular rib 120, to the ends of the elliptical piston 102. In some examples, stiffening segments may be positioned around the circular area where the bobbin will attach rather than a complete ring. In some examples, attachment points are provided in the form of nubs or pegs, which provide attachment area but do not contribute to stiffness of the piston, and do not significantly increase the moving mass. The bobbin may be similarly modified, with material removed between the points of attachment to the piston to reduce moving mass.

The effective moving mass can be further reduced by removing the LSR layer from the central region of the piston top, as shown in FIG. 7. After the silicon wafer is etched to form piston top 24 and release it from the substrate, and either before or after the bobbin and housing are assembled onto the plate and support ring, the LSR 22 in the central region is removed, creating an open area 200. For a 4 mm diameter driver, and a 70 μm thick layer of LSR, removing the inner 2.5 mm of the LSR from the top of the 2.9 mm piston removes 0.37 mg, which is 30% of the total mass of the piston top/suspension assembly, and 7% of the total moving mass of the driver if the support rib is also removed. Enough LSR is retained around the perimeter of the piston to maintain adhesion. For an elliptical piston and suspension with outer dimensions of 4 mm×7 mm, the savings from removing a corresponding amount of the LSR is 27% of the piston top/suspension assembly mass. Removing the LSR mass from the center of the piston also moves the frequency of resonant modes of the piston top out of the operating band of the transducer. The central region of the LSR layer can be removed using laser ablation, water cutting, chemical etching, or other techniques.

A number of implementations have been described. Nevertheless, it will be understood that additional modifications may be made without departing from the scope of the inventive concepts described herein, and, accordingly, other embodiments are within the scope of the following claims.

What is claimed is:

1. An apparatus comprising:
a solid piston comprising a closed shape;
a solid support surrounding the piston and corresponding in shape to the shape of the piston;
a layer of compliant material adhered to a top surface of the piston and a top surface of the support, the layer of compliant material comprising an open central area exposing the top surface of the piston through the open area.

2. The apparatus of claim 1, wherein the exposed portion of the piston comprises at least 50% of the surface area of the top surface of the piston.

3. The apparatus of claim 1, wherein the piston comprises a circular disc and the support comprises a circular ring.

4. The apparatus of claim 1, wherein the piston comprises an elliptical plate, and the support comprises an elliptical ring.

5. The apparatus of claim 1, wherein the piston comprises a shape that is longer in one dimension than another.

6. The apparatus of claim 1, wherein the piston further comprises support structures extending from a bottom surface of the piston, away from the compliant material layer.

7. The apparatus of claim 6, wherein the support structures do not form a closed shape.

8. The apparatus of claim 1, wherein the piston and support comprise silicon.

9. The apparatus of claim 1, wherein the compliant layer comprises liquid silicone rubber (LSR).

10. A method comprising:
adhering a layer of compliant material to a solid substrate;
removing a portion of the substrate to leave a piston, comprising a closed shape, and a support surrounding the piston, detached from the piston, and corresponding in shape to the shape of the piston, the piston and support being attached to each other by the complaint material layer;
removing a portion of the compliant material layer covering a central area of the piston, exposing a portion of the top surface of the piston through the opening created by removing the compliant material.

11. The method of claim 10, wherein the exposed portion of the piston comprises at least 50% of the surface area of the top surface of the piston.

12. The method of claim 10, wherein removing the portion of the silicon substrate causes the piston to be a circular disc and the support to be a circular ring.

13. The method of claim 10, wherein removing the portion of the silicon substrate causes the piston to be an elliptical plate, and the support to be an elliptical ring.

14. The method of claim 10, wherein removing the portion of the silicon substrate causes the piston to be a shape that is longer in one direction than in another.

15. The method of claim 10, wherein removing the portion of the silicon substrate causes the piston to further comprise a support structure extending from a bottom surface of the piston, away from the compliant material layer.

16. The method of claim 10, wherein the solid substrate comprises silicon.

17. The method of claim 10, wherein the compliant layer comprises liquid silicone rubber (LSR).

18. An assembly for an electroacoustic transducer, the assembly comprising:
a piston comprising an elliptical plate of silicon having a flat top surface and serving as the diaphragm;
an elliptical support ring of silicon surrounding the piston and separated from the piston by a gap; and
a layer of compliant material adhered to a top surface of the support ring and to the top surface of the piston, suspending the piston in the gap.

19. The assembly of claim 18, further comprising:
an elliptical bobbin adhered to a perimeter of the piston, and extending from the piston in a direction away from the layer of compliant material, and
an elliptical voice coil would around the bobbin.

20. The assembly of claim 19, wherein the piston further comprises a support structure extending from a bottom surface of the piston, away from the compliant material layer, at the perimeter of the piston.

21. The assembly of claim 18, further comprising:
a circular bobbin adhered to a bottom surface of the piston opposite the top surface, extending from the piston in a direction away from the layer of compliant material, and
a circular voice coil wound around the bobbin.

22. The assembly of claim 21, wherein the piston further comprises a support structure extending from a bottom surface of the piston, away from the compliant material layer, on a circular path corresponding to the shape of the bobbin.

23. The assembly of claim 18, wherein the layer of compliant material does not extend over the entire top surface of the piston.

24. An electroacoustic transducer, comprising:
a piston comprising an elliptical plate of silicon having a flat top surface and serving as the diaphragm;
an elliptical support ring of silicon surrounding the piston and separated from the piston by a gap, and coupled to a housing;
a layer of compliant material adhered to a top surface of the support ring and to the top surface of the piston, suspending the piston in the gap;
an elliptical bobbin adhered to a perimeter of the piston, and extending from the piston in a direction away from the layer of compliant material;
an elliptical voice coil would around the bobbin; and
an elliptical magnetic assembly positioned inside the bobbin and coupled to the housing.

25. The assembly of claim 24, wherein the layer of compliant material does not extend over the entire top surface of the piston.

26. An electroacoustic transducer, comprising:
a piston comprising an elliptical plate of silicon having a flat top surface and serving as the diaphragm;
an elliptical support ring of silicon surrounding the piston and separated from the piston by a gap, and coupled to a housing;
a layer of compliant material adhered to a top surface of the support ring and to the top surface of the piston, suspending the piston in the gap;
a cylindrical bobbin adhered to a perimeter of the piston, and extending from the piston in a direction away from the layer of compliant material;
a cylindrical voice coil would around the bobbin; and
a cylindrical magnetic assembly positioned inside the bobbin and coupled to the housing.

27. The assembly of claim 26, wherein the layer of compliant material does not extend over the entire top surface of the piston.
